(19) United States
(12) Patent Application Publication
(10) Pub. No.: US 2010/0258555 A1
(43) Pub. Date: Oct. 14, 2010

(54) DIRECT CURRENT ELECTROMAGNETIC HEATING ELEMENT

(76) Inventor: Sik Ping Cheung, Kowloon (HK)

Correspondence Address: Stephen B. Salai, Esq.;Harter Secrest & Emery LLP, 1600 Bausch & Lomb Place, Rochester, NY, 14604-2711, US

(21) Appl. No.: 12/745,702

(22) PCT Filed: Jul. 3, 2008
(86) PCT No.: PCT/CN08/01270

§ 371 Date: Jun. 2, 2010

(51) Int. Cl. H05B 6/04

(52) U.S. Cl. 219/660

(57) ABSTRACT

A direct current electromagnetic heating element using the principle of electro-heat energy transferring via the DC electromagnetic field is disclosed. When the direct current is passing through a coil and fully charges a closed magnetic field, the magnetic field would form an extra 2D heating space from the DC line circuit. The magnetic medium in this 2D heating space would expel enormous heat energy. Comparing to the common AC heating devices, the heating device with the circuit via the DC electromagnetic field would save more than 40% electric power consumption.

### FIELD OF THE INVENTION

The present invention relates to a heating element for heating an object, and more particularly a direct current electromagnetic heating element useful for heater.

### BACKGROUND OF THE INVENTION

Various heating methods are available today. However, considering reduction of green gas emission, it is more desirable to use electricity instead of conventional fossil fuels (such as gas and oil). There are various methods available using electricity, including resistance heating and induction heating. Resistance heating is a method of heating electrically by electric conductor carrying electric current therethrough. On the other hand, induction heating is a method of heating electrically conducting materials with alternating current (AC) electric power. Alternating current electric power is applied to an electrical conducting coil, like copper, to create an alternating magnetic field. This alternating magnetic field induces alternating electric voltages and current in a workpiece that is closely coupled to the coil. These alternating currents generate electrical resistance losses and thereby heat the workpiece. However, such heating methods consume enormous amount of energy, thus oil or gas heating has been traditionally preferred over conventional electric heating methods. Due to increasing demands for clean energy heating methods, it is desirous to have an alternative electric heating solution that would consume less energy or be more energy efficient for generating similar amount of heat.

### SUMMARY OF THE INVENTION

The present invention relates to a heating element for heating an object, and more particularly a direct current electromagnetic heating element useful for heater.

The object of the present invention is to provide a direct current electromagnetic heating element for heater, water heater and other application.

According to one aspect of the invention, it provides a direct current electromagnetic heating element, comprising at least one coil, whereby, when DC voltage is applied to the coil, it causes a closed magnetic field of fixed polarity being fully charged, and further causes the magnetic field to form an extra 2D heating space from the coil for expelling heat energy.

According to another aspect of the invention, it provides a heater comprising a direct current electromagnetic heating element that comprises at least one coil, whereby, when DC voltage is applied to the coil, it causes a closed magnetic field being fully charged, and further causes the magnetic field to form an extra 2D heating space from the coil for expelling heat energy.

According to yet another aspect of the invention, it provides a method of heating an object comprising the steps of: (i) applying a direct current voltage over at least one coil, causing a closed magnetic field of fixed polarity to be built and fully charged, and further causing said magnetic field to form an extra 2D heating space from said coil for expelling heat energy; and (ii). applying said heat energy to said object.

### BRIEF DESCRIPTION OF THE DRAWINGS

The invention will now be described in more detail with reference to the accompanying drawings, in which:

FIGS. 1 to 3 are a schematic diagrams of a DC circuit of direct current (“DC”) electromagnetic heater of the present invention;

FIGS. 4 to 5 are graphs showing voltage and current influence upon the magnetic field over time when AC voltage is applied over a coil;

FIGS. 6 and 7 are graphs showing voltage and current influence upon the magnetic field over time when DC voltage is applied to the coil;

FIG. 8 is a pictorial perspective view of a electromagnetic heater;

FIG. 9 is a schematic control circuit diagram of the electromagnetic heater;

FIG. 10 is a schematic diagram of a Controlled Environment Test Facility;

FIG. 11 is a table of test results of measuring a DC electromagnetic heater and AC oil radiator;

FIG. 12 shows a chart of the temperature rise over time measurements of the DC electromagnetic heater and the oil radiator; and

FIG. 13 shows a chart of the total power consumption over time measurements of the DC electromagnetic heater and the oil radiator.

### DETAILED DESCRIPTION OF THE INVENTION

The principle of electro-heat energy transferring via the Direct Current (“DC”) electromagnetic field is concerning to the electro-heat energy transferring. When the DC current passes through a coil and fully charges a closed magnetic field, this magnetic field forms an extra 2D heating space, a vertical space or another space, from the DC line circuit. The magnetic medium of the charged magnetic field would expel enormous heat energy.

In electrical technology, it is a general knowledge that a Current Transformer (“CT”) with opened circuit (or “secondary circuit”) could be damaged by overheating the transformer in the normal operation. The damage is caused by the electromagnetic field overly charged in the CT. Certainly this is acknowledged in the Alternative Current (“AC”) line circuit.

In fact, in the DC line circuit, when the DC current is passing through a coil and is fully charging a closed magnetic field, the magnetic medium in the electromagnetic field would also expel enormous heat energy. In the normal operation of this DC line circuit, there is no alternative inductive resistance but is only the pure interior resistance of the coil, thus it allows optimal amount of DC current to flow therethrough. Thus a very low DC voltage across the coil would be able to make a sufficient amount of DC current to pass through the coil and let the magnetic field fully charged. The power consumption of this DC circuit is very small, but it produces enormous capacity of heat energy in a steady, continuous and quiet manner.

There are two special features in this DC circuit as follow:

1. When the electromagnetic field takes part in the DC line circuit, it would form a new extra 2D heating space from the line circuit. The capacity/amount of the heat energy expelled from this space is even more enormous and steadier than that produced by an AC heating method.

2. Whether the electromagnetic field is or is not in existence in the DC line circuit, the power consumption of the whole circuit keeps still unchanged. In this circuit, the electric energy consumed by the coil transfers to the heat energy right truly according to the Joule's Law. However, it is believed that the heat energy from the 2D heating space of the DC magnetic field is excluded from the calculation accordingly to Joule's Law. Comparing to the common AC heating, this DC circuit with the magnetic field consumes much less power.

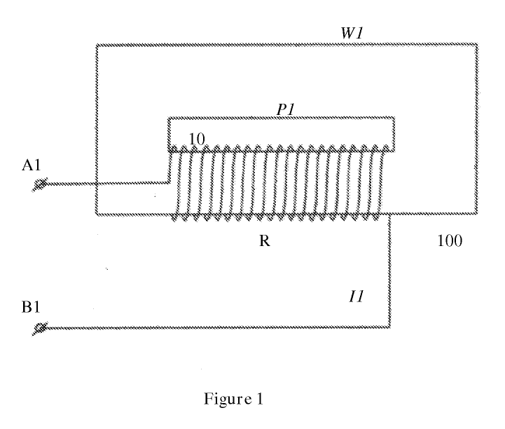

Now referring to FIGS. 1 to 3, a coil 10 having an interior resistance R; the current passing through the coil 10 in FIGS. 1, 2 and 3 are denoted as I1, I2 and I3; respectively. Similarly, the power consumptions at the coils 10 in FIGS. 1, 2 and 3 are denoted as W1, W2 and W3, respectively; and the power energies are denoted as P1, P2 and P3, respectively.

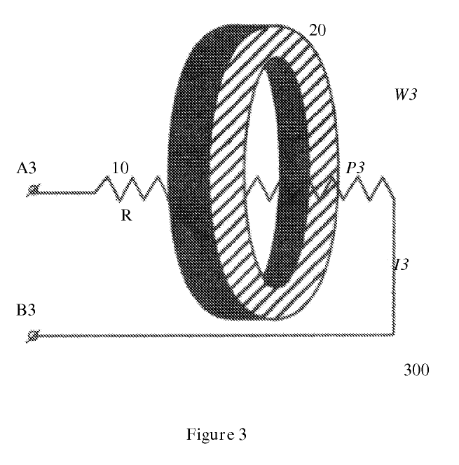

FIG. 1 shows a circuit diagram similar to a Current Transformer with only the primary coil 10, without having a secondary coil (not shown). When the DC voltage is applied across the coil 10, DC current I1 passes through the coil and charges the closed-circuit magnetic field. This DC electromagnetic field forms a new extra 2D heating space 20 (FIG. 3).

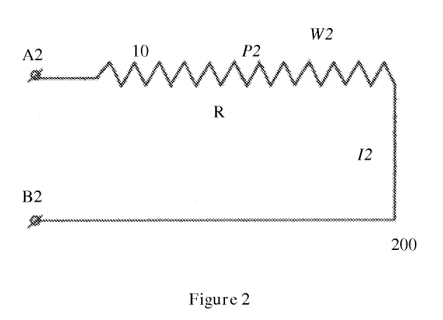

In FIG. 2, prior to the magnetic field is being formed, the power consumption of this circuit 200 is W2=I2²R watts, and power energy according to the Joule's Law: P2=W2t=I2² Rt Joules.

In FIG. 3, once the magnetic field takes part in the circuit 300, the voltage at the ends A3-B3 of the coil 10 and the current I3 passing the coil keep still unchanged as those in FIG. 2, i.e. I2=I3. This actually means that the power consumption of this DC line circuit would keep unchanged whether the magnetic field is or is not in existence. An extra 2D heating space 20 is newly rolled in while the power consumption of the whole circuit keeps unchanged as before. The total power energy of the circuit 300 by this time is:

P3=I3²Rt+2Dt as I3=I2, P3=I3²Rt+2Dt=I2²Rt+2Dt=P2+2Dt.

The result shows that the power consumptions of the circuits 200 and 300 remain equal in value but the power energy of the circuit 300 has a 2Dt more than that of the circuit 200.

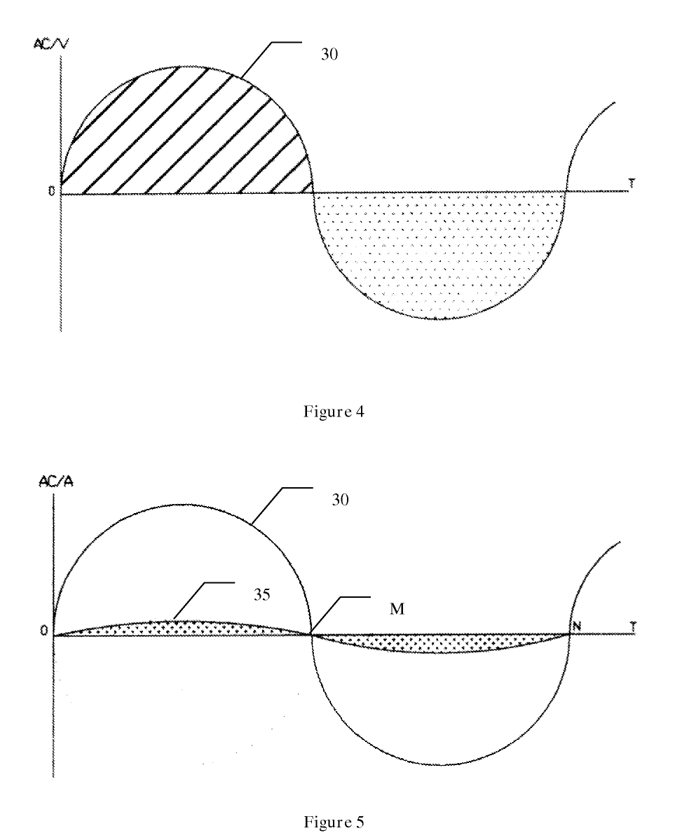

FIG. 4 illustrates voltage 30 changes in one cycle over time at A1-B1, A2-B2 or A3-B3 of FIG. 1, 2 or 3, respectively, when AC voltage is applied thereto. For many countries, AC is provided at 50 or 60 Hz, thus the voltage 30 cycles 50 or 60 times per second. As it is illustrated in FIG. 4, the voltage 30 is positive in the first half of a cycle and the voltage swings to negative in the second half of the cycle.

FIG. 5 illustrates voltage 30 and current 35 changes over time through the coil 10 in FIG. 1, 2 or 3. As AC voltage 30 alternates between positive and negative (by drawing a sine wave over time), the current 35 that flowing through the coil 10 would also alternate accordingly to the voltage 30. Besides the interior resistance R of the coil 10, the amount of the AC current flowing through the coil 10 would be proportional mainly to the inductive resistance of the coil 10. A magnetic field that is built up around the coil 10 in the first half cycle (i.e. between 0 and M) would, however, be upset and cleared by another magnetic field being built up during the second half cycle (i.e. between M and N). Any magnetic field that is being built in any given half cycle is disrupted or affected by a magnetic field being built in its precursor half cycle and is affecting a following magnetic. In addition, the substantially charged value of a magnetic field in every one whole cycle would be zero.

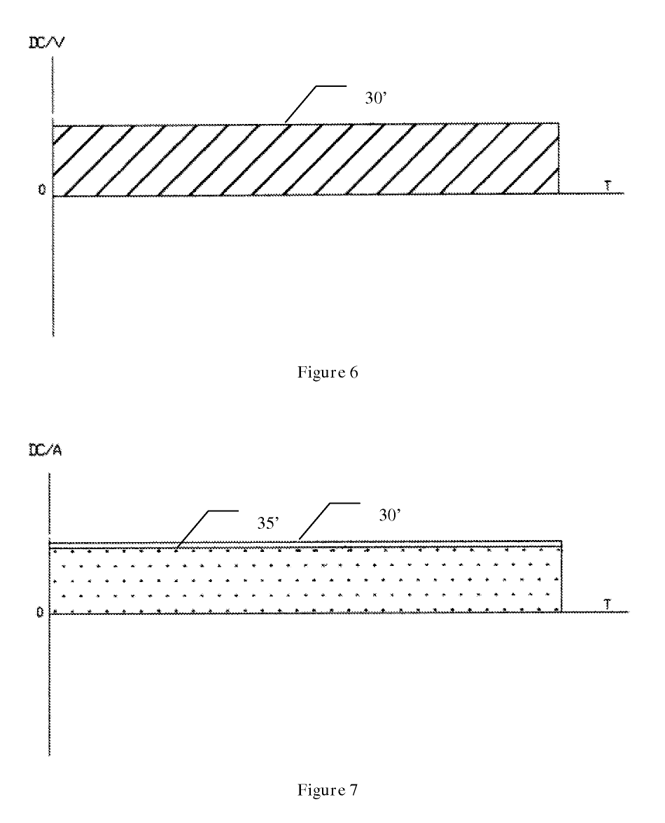

FIG. 6 illustrates DC voltage 30′ value over time at A1-B1, A2-B2 or A3-B3 of FIG. 1, 2 or 3, respectively, when DC voltage is applied thereto. As it can be seen in FIG. 7, DC current 35′ reaches to its proportional amount only by overcoming the interior resistance R of the coil 10. Such DC current 35′ through the coil 10 over time would efficiently build a magnetic field. It is believed that such process also stimulates further heat generation. Unlike in the case of AC voltage, when a DC voltage is applied to the coil 10, since the voltage remains unchanged to charge a same field of fixed directional polarity, there is no reactive voltage as in the case when AC voltage was applied to the coil 10. The application of DC voltage to the coil 10 effectively charges and energizes the magnetic field around the coil 10, thus highly intensifying its charging to the magnetic field for heat transferring.

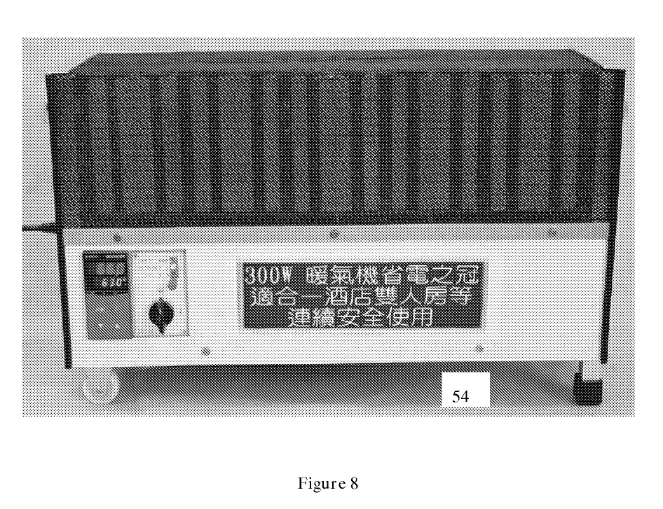

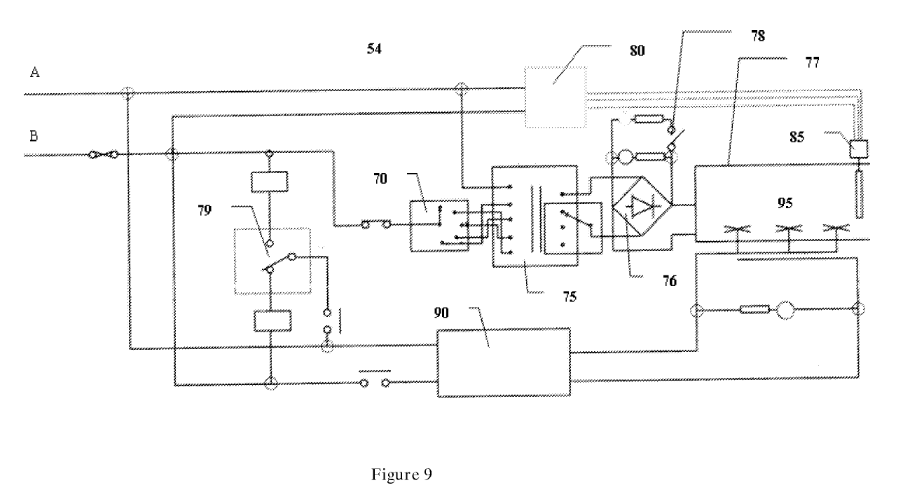

FIG. 8 shows a 300 W DC electromagnetic heater 54 according to the foregoing principle of electro-heat energy transferring via DC electromagnetic field. The heater comprises five (5) coils, being connected in series. The core of each of the coils has dimension of 32 mm×62 mm, having enamel copper wire gauge of 19# or 1.12 mm diameter wound therearound 43 turns per layer and up to six (6) layers, thus in total, 258 turns per coil. (The heater 54 comprises five (5) coils, thus in effect, contains total 1290 turns). The power source for this heater is DC 48-60V/5.5-6.5 A.

FIG. 9 shows a schematic control circuit diagram of the heater 54. AC voltage is supplied to the heater 54 at the terminals A and B. The heater 54 comprises at a transformer 75 connected via switch 70 for selecting the length of the primary winding for controlling amount of heat generated by the coils (not shown) under a heat sink 77. A bridge rectifier 76 is connected to the secondary winding of the transformer 75 for converting AC voltage to DC voltage. The heater 54 further comprises a temperature monitor 80 sampling the temperature of the heat sink 77 of the heater 54 at a temperature sampling terminal 85. The heater 54 also comprises a plurality of fans 95 for generating air flow to effectively radiating heat outside the heater 54 and control the heater operating within the designated temperature. The fans 95 are connected and controlled by fan power supply 90. The fans power supply 90 is in communication with the temperature monitor 80, and is controlled by a signal from the temperature monitor 80, by switching on the fans 95 to cool down the heat sink temperature or stopping the fans 95 in stand-by for the next cooling. Preset the temperature monitor 80 by adjusting the desired start on/off point and differential range to control temperature of this heater within the desired temperature range.

The heater 54 was tested in the Controlled Environment Test Facility of Hong Kong University of Science & Technology, by comparing it with an “Oil Radiator” heater manufactured in Europe (i.e. by Whirlpool), for measuring and comparing the performances of the DC electromagnetic heater and the Oil Radiator. The Oil Radiator generates 2000 W of heat power.

Test Facility:

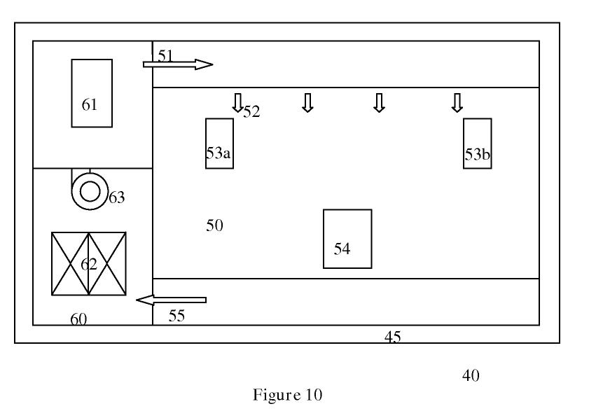

FIG. 10 shows a schematic diagram of the Controlled Environment Test Facility 40. The Facility 40 is of a closed loop air circulation, enclosed by insulation material 45 for preventing heat leak from/to inside the Facility 40. The Facility 40 has two sections, namely testing section 50 and reconditioning section 60. In the reconditioning section 60, there is the reconditioning equipments, comprising a reconditioning heater 61 and reconditioning cooling coil 62 for controlling ambient temperature inside the Facility 40 and reconditioning fan 63 for circulating air. In the testing section 50, supply air 51 that is being conditioned in the reconditioning section 60 is blow out, generating laminar flow 52. Two room temperature sampling units 53a and 53b are placed in the middle of the testing section 50 for collecting and measuring the ambient temperature of the Facility 40. A unit under test 54 is also placed inside the testing section 50. Return air 55 is collected and entered back into the reconditioning section 60.

Test Setup and Procedure:

A unit under test is placed inside the Controlled Environment Test Facility 40, and is kept to be in operation. The temperature of the Controlled Environment Test Facility 40 is set to 18° C., and maintained at that temperature by the reconditioning equipments. Two room temperature sampling units 53a and 53b are placed in the middle of the testing section 50 and being fixed during tests. Once the ambient temperature inside the Facility 40 is maintained steadily at 18.0° C. for one hour, the reconditioning heater 61 and reconditioning cooling coil 62 are turned off, while the reconditioning fan is remained in operation throughout the test. The ambient temperature is measured and recorded every minute by the two room temperature sampling units 53a and 53b. The test continues till the ambient temperature inside the Facility 40 reaches to 28.0° C. Total power consumption by the unit under test is measured and recorded every minutes by a power meter, i.e. Yokogawa® Power Meter WT-110. The ambient temperature inside the Facility 40 is recorded every minutes using a hybrid recorder, i.e. Yokogawa® Hybrid Recorder DR-242. For the room temperature sample units 53a and 53b, Chino® Resistance Thermometer (Sampling Unit) Pt-100s are used.

Test Results:

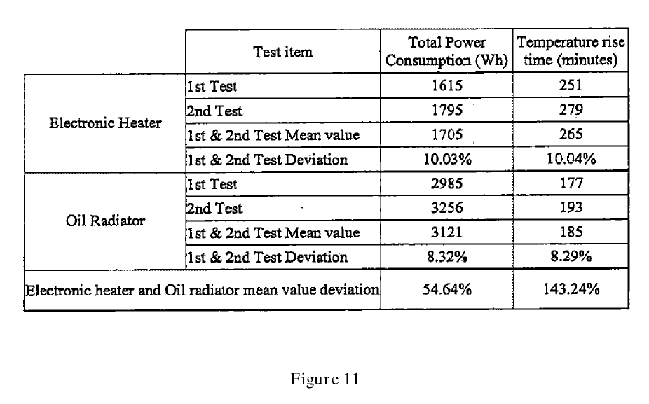

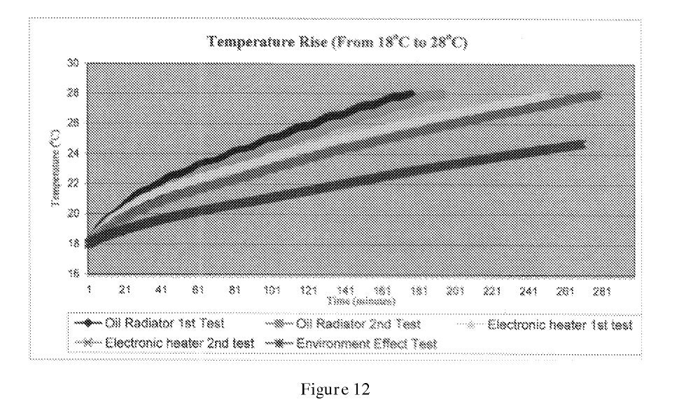

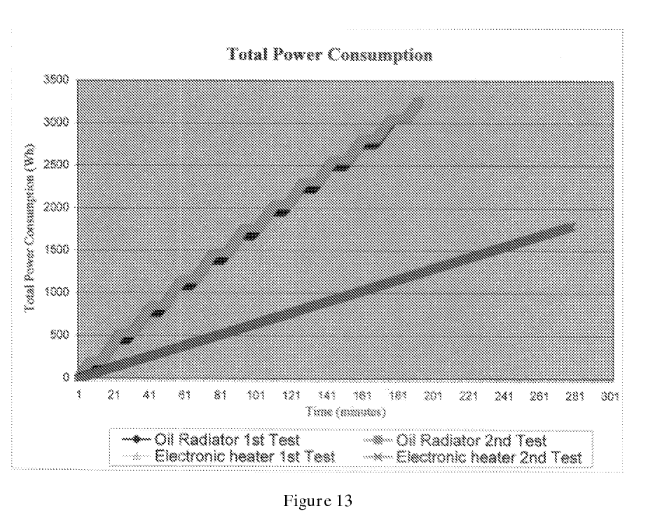

Each of DC electromagnetic heater and Oil Radiator was tested independently, twice, under the same testing conditions/procedure. The results of their operations were recorded and compared in FIG. 11. FIG. 12 is a chart of the temperature rise over time. FIG. 13 is a chart of total power consumption over time. As it is shown in FIG. 11, the DC electromagnetic heater consumed an average of 1705 WH to raise the testing room temperature from 18° C. to 28° C., while the Oil Radiator consumed an average of 3121 WH to achieve the same result. In theory, two heaters should expel same amount of heat energy to raise the same room temperature from 18° C. to 28° C. Furthermore, according the calculation of the Joule's Law, 1705 WH should not produce as same amount of heat energy as that of 3121 WH by Oil Radiator produced. As it can be seen in FIG. 13, the oblique line of the oil radiator exhibits a stepping line; however, the lines for electromagnetic heater are rather continuous and straight. It is to be noted that the stepping line of the oil radiator is caused by the oil radiator cutting off the power supply to control and keep the heat sink temperature from overheating. It was observed that the temperature of the electromagnetic heater was controlled within a very small variation range. It was also observed that the heat sink temperature of oil radiator heater was within 52° C.-72° C. (20° C. range); however, the heat sink temperature of electromagnetic heater was within 61° C.-64° C. (3° C. range). This means that electromagnetic heating is a very stable heating method. Since the electromagnetic heater uses a low voltage (about 60 V), this is a safer way for heating an object than other conventional ways.

Since two heaters (Oil Radiator and DC electromagnetic heater) produced same capacity of heat energy:

3121WH=1705WH+2Dt, thus

2Dt=3121WH−1705WH=1416WH.

In other words, the 2D space of the DC electromagnetic heater has produced 1416WH heat energy within the 265 minutes testing period, providing more than 40% energy savings for generating same amount of heat as the Oil Heater.

It is to be understood that the embodiments and variations shown and described herein are merely illustrations of the principles of this invention and that various modifications may be implemented by those skilled in the art without departing from the spirit and scope of the invention.

What is claimed is:

1. A direct current electromagnetic heating element, comprising at least one coil, when DC voltage is applied to said at least one coil, causing a closed magnetic field of fixed polarity to be fully charged, and further causing said magnetic field to form an extra 2D heating space from said coil for expelling heat energy.

2. A heater comprising a direct current electromagnetic heating element, said direct current electromagnetic heating element comprises at least one coil, when DC voltage is applied to said at least one coil, causing a closed magnetic field of fixed polarity to be fully charged, and further causing said magnetic field to form an extra 2D heating space from said coil for expelling heat energy.

3. The heater as recited in claim 2 wherein said at least one coil, when DC voltage is applied to said at least one coil, reduces inductive reactance and provides a pure interior resistance for allowing optimal amount of DC current to flow therethrough to reduce power consumption.

4. The heater as recited in claim 2 further comprising a temperature monitor and at least one temperature sampling terminal being in communication with said monitor for monitoring and adjusting temperature of the heat generated by said heating element, and a switch actuated by said monitor for regulating said DC voltage to said at least one coil, said sensor monitoring said temperature for controlling the heater within a designated temperature.

5. The heater as recited in claim 2 wherein said at least one coil is connected in series.

6. A method of heating an object comprising the steps of:
(i) applying a direct current voltage over at least one coil, causing a closed magnetic field of fixed polarity being built and fully charged, and further causing said magnetic field to form an extra 2D heating space from said coil for expelling heat energy; and
(ii) applying said heat energy to said object.
